(19) United States
(12) Patent Application Publication
(10) Pub. No.: US 2024/0311261 A1
(43) Pub. Date: Sep. 19, 2024

(54) DATA MANAGEMENT APPARATUS AND DR COST CALCULATION SUPPORT METHOD

(71) Applicant: Hitachi, Ltd., Tokyo (JP)

(72) Inventors: Noriko ICHIKAWA, Tokyo (JP); Jun Nakajima, Tokyo (JP); Koichi Murayama, Tokyo (JP)

(73) Assignee: Hitachi, Ltd., Tokyo (JP)

(21) Appl. No.: 18/459,633

(22) Filed: Sep. 1, 2023

(30) Foreign Application Priority Data
Mar. 14, 2023 (JP) 2023-039453

(51) Int. Cl. G06F 11/20

(52) U.S. Cl. CPC G06F 11/2025; G06F 2201/85

(57) ABSTRACT

Upon acquiring target business specifying information for specifying a target business, disaster recovery (DR) operation phase determination processing of calculating an operation phase is executed based on copy configuration information for managing a pair configuration of a target business use volume and a copy volume and a copy status table for managing a copy status in the target business use volume and the copy volume, a disaster pattern corresponding to a disaster situation of a volume of a disaster target having been damaged is calculated in accordance with an operation phase calculated by the DR operation phase determination unit, and a cloud use fee is calculated for each disaster pattern from a failure occurrence to completion of system recovery of a use site where a use volume is created.

### BACKGROUND OF THE INVENTION

### 1. Field of the Invention

The present invention relates to a data management apparatus that generates information regarding damage to a volume and a disaster recovery (DR) cost calculation support method.

### 2. Description of the Related Art

There is a technology called failover in which when a failure occurs in a normally used server in an on-premises environment, an alternative server is used to take over the processing of the normally used server. In the alternative server, a copy of the normally used server is created. In many cases, alternative servers can be constructed less expensively in a cloud environment than in an on-premises environment. Therefore, in many cases, alternative servers are constructed in a cloud environment. There is a technology related to the cost of an alternative server of a cloud environment used in the failover.

For example, the technology described in JP 2020-129184 A uses a first server in an on-premises environment that executes a service and a second server in a virtual environment in which execution of the service of the first server is failed over when a disaster (failure) occurs in the first server. In the technology described in JP 2020-129184 A, the second server in the virtual environment is created as a spot instance in a cloud environment that can be used at a low price.

There is a possibility that the second server created in the spot instance of the cloud environment is forcibly shut down by a cloud operator, and can be used at a lower price than a server created in a normal instance. In the technology described in JP 2020-129184 A, when it is detected that the second virtual server can no longer be used due to the cloud operator's execution of forced shutdown, a third virtual server that copies and takes over information of an instance of the second virtual server is created, and the third virtual server is used instead of the second virtual server. Use of the technology described in JP 2020-129184 A makes it possible to use a server of a virtual environment used for failover while suppressing the cost when no failure occurs.

### SUMMARY OF THE INVENTION

In the case of using the technology described in JP 2020-129184 A, the suppressible cost is the cost (referred to as “in-operation normal time cost”) of the second server (alternative server) when no failure occurs in the first server (normally used server). The second server (alternative server) is a server provided at a DR site in a cloud environment used to prepare for a failure (disaster). Data used by the server is stored in a volume.

When operating a DR site, it is desirable to consider the overall cost of the DR site. The overall cost of the DR site includes costs other than the in-operation normal time cost. For example, the overall cost of a DR site in a virtual environment includes the cost at the time of disaster of the volumes of the following 1 and 2.
1. Cost for reading and writing data from a volume created in a DR site in a cloud environment by failover (referred to as “cost of failover”)
2. Cost required for reading data from the volume created in the DR site in order to recover the normally used server (referred to as “cost for reading data”).

In many cases, these costs at the time of disaster of these 1 and 2 vary depending on the capacity of the volume created in the DR site, the amount of data read from the volume created in the DR site, and the like. Therefore, there is a demand for a technology capable of easily calculating the costs at the time of disaster of 1 and 2.

In order to operate the DR site in a cloud environment, there is a case of judging whether or not to use a volume for the DR site in the cloud environment in consideration of the overall cost of the DR site in the cloud environment including the costs at the time of disaster of these 1 and 2. In particular, when DR sites in a plurality of cloud environments are used with reduced costs, there is a case of being required to be capable of easily calculating the costs at the time of disaster of these 1 and 2.

Therefore, an object of the present invention is to provide a data management apparatus and a DR cost calculation support method that support the operation of a DR site by calculating the cost at the time of disaster of the volume of the DR site in a virtual environment.

In order to achieve the above object, one aspect of a DR cost calculation support method of the present invention is a DR cost calculation support method in a data management apparatus that generates information regarding a disaster of a volume, the DR cost calculation support method, in which the data management apparatus includes a storage device and a processor, the storage device stores copy configuration information for storing, in association with each other, business specifying information for specifying business, information of a use volume used in business, and information of a copy volume constituting a pair of a use volume and a backup or DR, and cloud cost information for storing, in association with each other, a site in a cloud environment and information regarding a cost required for using a volume of the site in the cloud environment, and the processor executes upon acquiring target business specifying information for specifying a target business, DR operation phase determination processing of calculating an operation phase of an operation of a cloud DR copy volume of a cloud site with respect to a target business use volume based on information of a copy volume with respect to a target business use volume used in a target business with reference to the copy configuration information, support pattern calculation processing of calculating a disaster pattern that can occur in a volume of a disaster target in accordance with an operation phase calculated by the DR operation phase determination unit, and calculating a set of volume copies of the volume of the disaster target and a copy volume storing data to be recovered and copied to the volume of the disaster target in a support to a calculated disaster pattern, and disaster support cost calculation processing of calculating, using the cloud cost information, a use fee of a DR site in the cloud environment from occurrence of a failure in the disaster pattern calculated by the support pattern calculation unit to completion of system recovery of a use site where a use volume is created.

One aspect of a data management apparatus of the present invention is a data management apparatus that generates information regarding a disaster of a volume, the data management apparatus including: a storage unit, a DR operation phase determination unit, a support pattern calculation unit, and a disaster support cost calculation unit, in which the storage unit stores copy configuration information for storing, in association with each other, business specifying information for specifying business, information of a use volume used in business, and information of a copy volume constituting a pair of a use volume and a backup or DR, and cloud cost information for storing, in association with each other, a site in a cloud environment and information regarding a cost required for using a volume of the site in the cloud environment, and the DR operation phase determination unit executes upon acquiring target business specifying information for target business, DR operation phase determination processing of calculating an operation phase of an operation of a cloud DR copy volume of a cloud site with respect to a target business use volume based on information of a copy volume with respect to a target business use volume used in a target business with reference to the copy configuration information, the support pattern calculation unit executes support pattern calculation processing of calculating a disaster pattern that can occur in a volume of a disaster target in accordance with an operation phase calculated by the DR operation phase determination unit, and calculating a set of volume copies of the volume of the disaster target and a copy volume storing data to be recovered and copied to the volume of the disaster target in a support to a calculated disaster pattern, and the disaster support cost calculation unit disaster support cost calculation processing of calculating, using the cloud cost information, a use fee of a DR site in the cloud environment from occurrence of a failure in the disaster pattern calculated by the support pattern calculation unit to completion of system recovery of a use site where a use volume is created.

According to a representative embodiment of the present invention, operation of a DR site is supported by calculating the cost at the time of disaster of the volume of the DR site in a virtual environment. Problems, configurations, and effects other than those described above will be clarified by the following description of examples.

### BRIEF DESCRIPTION OF THE DRAWINGS

FIG. 1 is a diagram illustrating an example of a functional block diagram of a data management apparatus of an example;

FIG. 2 is an explanatory diagram explaining disaster to data;

FIG. 3 is an explanatory diagram explaining a data recovery method;

FIG. 4 is a block diagram illustrating a hardware configuration example of the data management apparatus;

FIG. 5 is a diagram illustrating an example of a volume group table 31;

FIG. 6 is a diagram illustrating an example of a service level management table 32;

FIG. 7 is a diagram illustrating an example of a main site disaster support pattern table 33;

FIG. 8 is a diagram illustrating an example of a copy configuration table 34;

FIG. 9 is a diagram illustrating an example of a copy status table 35;

FIG. 10 is a diagram illustrating an example of a business data use status table 36;

FIG. 11 is a diagram illustrating an example of a public cloud cost table 37;

FIG. 12A is a diagram illustrating an example of a disaster support cost table 38A;

FIG. 12B is a diagram illustrating an example of a disaster support cost table 38B;

FIG. 12C is a diagram illustrating an example of a disaster support cost table 38C;

FIG. 13 is a diagram illustrating an example of a cost analysis screen;

FIG. 14 is a flowchart showing an example of DR operation phase determination processing of the example;

FIG. 15 is a flowchart showing an example of pre-operation support pattern calculation processing of the example;

FIG. 16 is a flowchart showing an example of in-operation normal time support pattern calculation processing of the example;

FIG. 17 is a flowchart showing an example of in-operation disaster support pattern calculation processing of the example;

FIG. 18 is a flowchart showing an example of disaster support cost calculation processing of the example; and

FIG. 19 is a diagram illustrating an example of the cost analysis screen.

### DESCRIPTION OF THE PREFERRED EMBODIMENTS

Hereinafter, examples of the present invention will be described with reference to the drawings. However, the present invention is not to be construed as being limited to the description content of the following examples. Those skilled in the art can easily understand that the specific configuration can be changed without departing from the spirit or gist of the present invention.

In the configurations of the invention described below, the same or similar configurations or functions are denoted by the same reference signs, and redundant description is omitted.

Notations such as “first”, “second”, and “third” in the present description and the like are attached to identify components, and do not necessarily limit the number or order.

In the present description and the like, as an example of various types of information, an expression of “XX table” may be used for description, but they may be expressed by a data structure such as “XX list” or “XX queue”. The “XX table” may be “XX information”. In describing the identification information, expressions such as “identification information”, “identifier”, “name”, “ID”, and “number” are used, and these can be replaced with one another.

### <System Configuration>

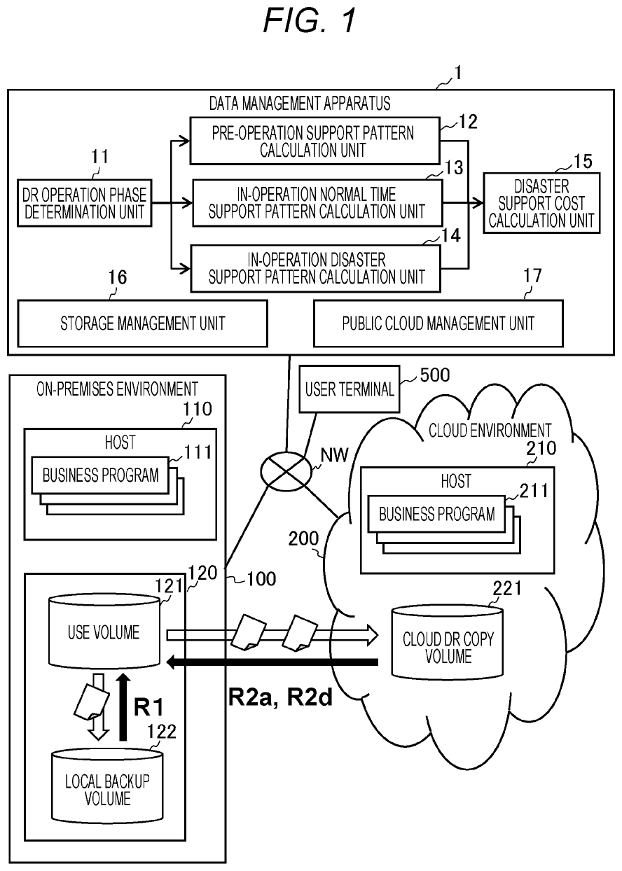

FIG. 1 is an explanatory diagram explaining an outline of the function of a data management apparatus 1 of an example. As illustrated in FIG. 1, the data management apparatus 1 is connected to an on-premises system 100, a cloud site 200, and a user terminal 500 via a network NW.

The on-premises system 100 includes a host device 110 and an on-premises storage system 120. The host device 110 stores a plurality of business programs 111. The host device 110 is accessed by the user terminal 500 via the network NW. By operating the user terminal 500, the user of the user terminal 500 can use the business programs 111 of the host device 110 via the user terminal 500.

In the on-premises storage system 120, a volume is created. In the on-premises storage system 120, a use volume 121 for storing data created by the business program 111 of the host device 110 and a local backup volume 122, which is a backup of the use volume 121, are created. In the local backup volume 122, a copy of the use volume 121 is created every predetermined time. The use volume 121 is a use volume used in business.

The cloud site 200 is a site where a cloud DR copy volume 221 synchronized with the use volume 121 is created. In the example of FIG. 1, the cloud site 200 includes an alternative host device 210, which is an alternative to the host device 110, and the cloud DR copy volume 221, which is a copy of the use volume 121.

The alternative host device 210 is created for failover. That is, when the host device 110 is damaged, the alternative host device 210 takes over the processing of the host device 110, whereby the alternative host device 210 can alternate in the function of the host device 110.

The network NW may be a wired network or a wireless network. The network NW may be a global network such as the Internet.

As described above, copies of the use volume 121 of the on-premises storage system 120 are created in the local backup volume 122 and the cloud DR copy volume 221. When the use volume 121 is damaged, the use volume 121 can be recovered using the local backup volume 122 or the cloud DR copy volume 221.

Note that the local backup volume 122, the cloud DR copy volume 221, or the cloud site 200 may be configured not to exist. The data management apparatus 1 can respond to a configuration in which the local backup volume 122, the cloud DR copy volume 221, or the cloud site 200 does not exist.

As illustrated in FIG. 1, the data management apparatus 1 includes a DR operation phase determination unit 11, a pre-operation support pattern calculation unit 12, an in-operation normal time support pattern calculation unit 13, an in-operation disaster support pattern calculation unit 14, a disaster support cost calculation unit 15, a storage management unit 16, and a public cloud management unit 17.

The DR operation phase determination unit 11 calculates an operation phase of the operation of the cloud DR copy volume 221 of the cloud site 200 in a cloud environment with respect to the use volume 121.

The operation phase is a state of the use volume 121 and the cloud DR copy volume 221. The operation phase includes three phases of “pre-operation”, “in-operation normal time”, and “in-operation disaster”. The operation phase may include phases other than these three phases.

The “pre-operation” is a state where the cloud DR copy volume 221 is not created. The “in-operation normal time” is a state where the cloud DR copy volume 221 is created and the use volume 121 and the like are not damaged and can be used normally. The “in-operation disaster” is a state where the cloud DR copy volume 221 is created and the use volume 121 and the like cannot be used normally.

The pre-operation support pattern calculation unit 12 executes the pre-operation support pattern calculation processing when the operation phase calculated by the DR operation phase determination unit 11 is “pre-operation”. In the pre-operation support pattern calculation processing, in a case of “pre-operation”, a disaster pattern in which a volume of a disaster target having been damaged is generated is calculated in a state where the cloud DR copy volume 221 is created. The disaster pattern represents situations of a volume in which data is copied from a use volume and the use volume as a degree of failure (degree of disaster). Then, in the disaster pattern pre-operation support pattern calculation processing, a set of volume copies of the volume of the disaster target and the copy volume storing the data to be recovered and copied to the volume of the disaster target in the support to the calculated disaster pattern is calculated. Here, the set of volume copies includes a set of the use volume 121 and the local backup volume 122 illustrated in FIG. 1 (R1 in FIG. 1) and a set of the use volume 121 and the cloud DR copy volume 221 (R2a and R2d in FIG. 1).

The in-operation normal time support pattern calculation unit 13 executes the in-operation normal time support pattern calculation processing when the operation phase calculated by the DR operation phase determination unit 11 is “in-operation normal time”.

The in-operation disaster support pattern calculation unit 14 executes the in-operation disaster support pattern calculation processing when the operation phase calculated by the DR operation phase determination unit 11 is “in-operation disaster”.

The pre-operation support pattern calculation unit 12, the in-operation normal time support pattern calculation unit 13, and the in-operation disaster support pattern calculation unit 14 are support pattern calculation units that execute support pattern calculation processing.

The pre-operation support pattern calculation processing, the in-operation normal time support pattern calculation processing, and the in-operation disaster support pattern calculation processing are support pattern calculation processing. In the support pattern calculation processing, the DR operation phase determination unit calculates a disaster pattern that can occur in the volume of the disaster target in accordance with the operation phase calculated by executing the DR operation phase determination processing, and calculates a set of volume copies of the volume of the disaster target and the copy volume storing data to be recovered and copied in the volume of the disaster target in the support to the calculated disaster pattern.

The disaster support cost calculation unit 15 executes disaster support cost calculation processing of calculating and outputting a use fee of a DR site in the cloud environment from occurrence of a failure in the disaster pattern calculated by the support calculation unit (the pre-operation support pattern calculation unit 12, the in-operation normal time support pattern calculation unit 13, and the in-operation disaster support pattern calculation unit 14) to completion of system recovery of a use site where a use volume is created.

The storage management unit 16 can monitor and operate resources such as a volume created in the on-premises storage system 120.

The public cloud management unit 17 can monitor and operate resources such as a host instance and a volume created in the cloud site 200. Billing information in cloud use is also managed here.

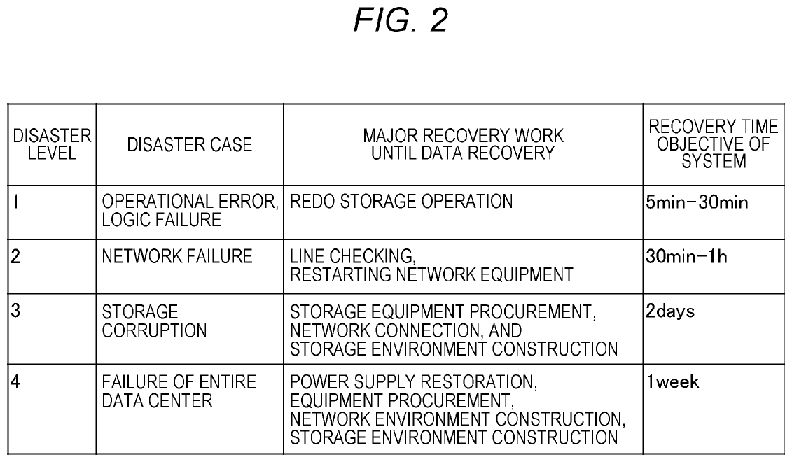

As illustrated in FIG. 2, there are various causes of damage to the use volume 121. There are various methods of data recovery of the use volume 121. Furthermore, the length of recovery time objective of the system varies depending on the state of disaster.

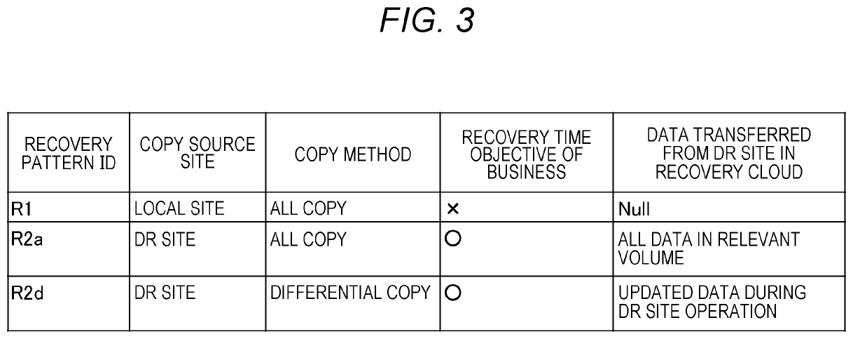

As illustrated in FIG. 3, there are various aspects of copy of data in recovery. The recovery pattern ID of FIG. 3 indicates a set of volume copies of the volume of the disaster target and the copy volume storing data to be copied to the volume of the disaster target in the support to the disaster pattern. The recovery pattern IDs R1, R2a, and R2d are illustrated in FIG. 1. The data management apparatus 1 has the following configuration so that the cost required for recovery can be calculated.

### <Hardware Configuration of Data Management Apparatus 1>

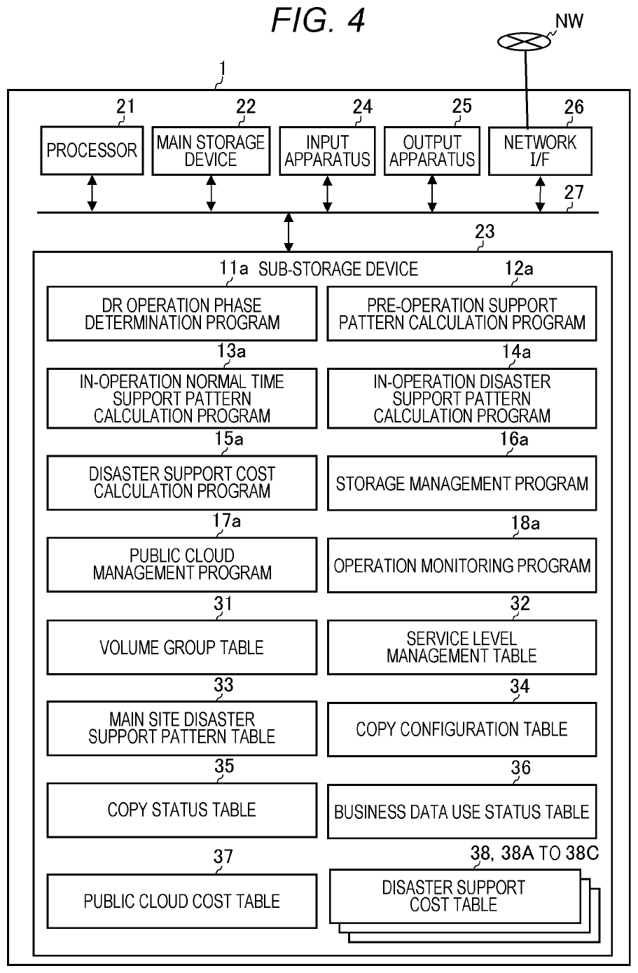

FIG. 4 is a block diagram illustrating a hardware configuration example of the data management apparatus 1. As illustrated in FIG. 4, the data management apparatus 1 includes a processor 21, a main storage device 22, a sub-storage device 23, an input apparatus 24, an output apparatus 25, a network I/F 26, and a bus 27 that connects them. The data management apparatus 1 can be implemented by a general information processing apparatus such as a PC or a server computer.

The processor 21 reads data and a program stored in the sub-storage device 23 to the main storage device 22, and executes processing defined by the program. The DR operation phase determination unit 11 described above with reference to FIG. 1 is implemented by the processor 21 reading, into the main storage device 22, and executing a DR operation phase determination program 11a stored in the sub-storage device 23. Similarly, the pre-operation support pattern calculation unit 12, the in-operation normal time support pattern calculation unit 13, the in-operation disaster support pattern calculation unit 14, the disaster support cost calculation unit 15, the storage management unit 16, and the public cloud management unit 17 are implemented by the processor 21 reading, into the main storage device 22, and executing a pre-operation support pattern calculation program 12a, an in-operation normal time support pattern calculation program 13a, an in-operation disaster support pattern calculation program 14a, a disaster support cost calculation program 15a, a storage management program 16a, and a public cloud management program 17a, respectively.

In the present description, when processing is described in a sentence having the DR operation phase determination unit 11, which is a functional unit, as a subject, it indicates that the processor 21 is executing the program (the DR operation phase determination program 11a) that implements the functional unit. Similarly, when processing is described in a sentence having, as a subject, the pre-operation support pattern calculation unit 12, the in-operation normal time support pattern calculation unit 13, the in-operation disaster support pattern calculation unit 14, the disaster support cost calculation unit 15, the storage management unit 16, and the public cloud management unit 17, which are functional units, it indicates that the processor 21 is executing the program (the pre-operation support pattern calculation program 12a, the in-operation normal time support pattern calculation program 13a, the in-operation disaster support pattern calculation program 14a, the disaster support cost calculation program 15a, the storage management program 16a, and the public cloud management program 17a), respectively, that implement the functional units.

The main storage device 22 is a RAM or the like, ha a volatile storage element, and stores a program executed by the processor 21 and data.

The sub-storage device 23 is a device that is a hard disk drive (HDD), a solid state drive (SSD), or the like, has a nonvolatile storage element, and stores a program, data, or the like. The sub-storage device 23 has the DR operation phase determination program 11a, the pre-operation support pattern calculation program 12a, the in-operation normal time support pattern calculation program 13a, the in-operation disaster support pattern calculation program 14a, the disaster support cost calculation program 15a, the storage management program 16a, the public cloud management program 17a, and an operation monitoring program 18a installed. The sub-storage device 23 stores a volume group table 31, a service level management table 32, a main site disaster support pattern table 33, a copy configuration table 34, a copy status table 35, a business data use status table 36, a public cloud cost table 37, and a disaster support cost table 38 (disaster support cost tables 38A to 38C).

The storage management program 16a is a program used for management of a storage. The public cloud management program 17a is a program used for management of a public cloud. The processor 21 reads, into the main storage device 22, and executes the storage management program 16a and the public cloud management program 17a, and the copy configuration table 34 is created. The operation monitoring program 18a is a program for acquiring information on a configuration of a volume and reading and writing of data of the volume. The processor 21 reads, into the main storage device 22, and executes the operation monitoring program 18a, and the copy status table 35 and the business data use status table 36 are created.

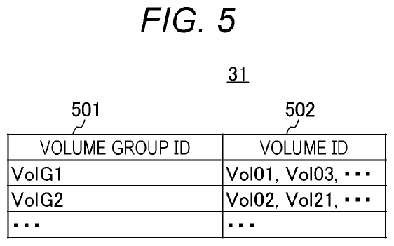

Although details will be described later with reference to FIG. 5, the volume group table 31 stores information of the volume ID of the volume included in a volume group. The volume group is a group of volumes in which a plurality of volumes are put together. A plurality of volumes are associated with one volume group. The data management apparatus 1 can acquire the volume ID of the volume included in the volume group with reference to the volume group table 31.

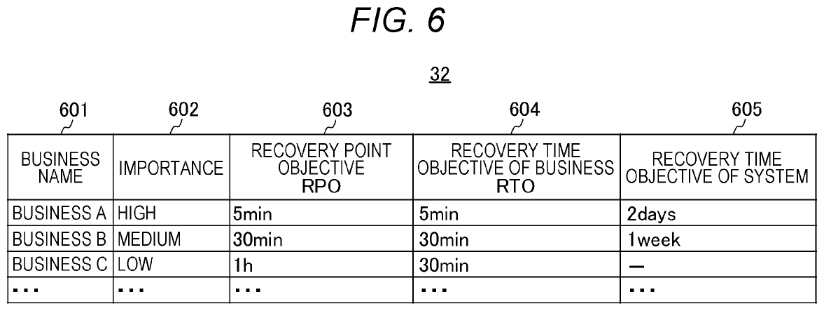

Although details will be described later with reference to FIG. 6, the service level management table 32 stores information regarding a target time interval required for recovery of data regarding business.

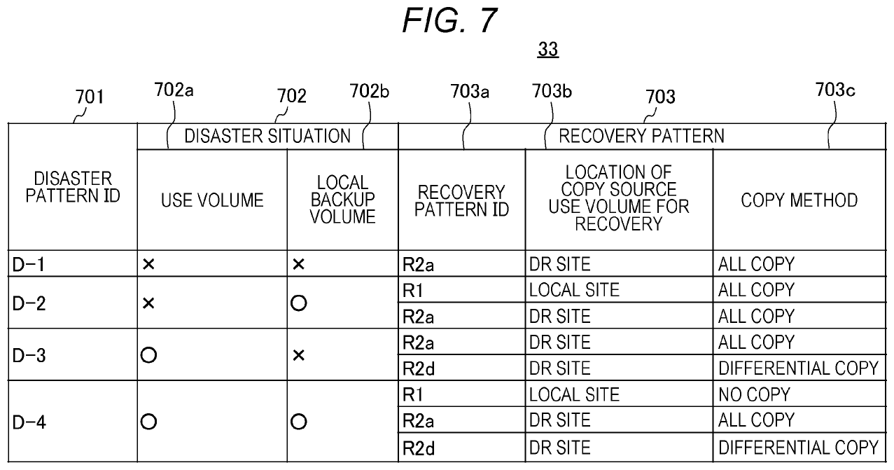

Although details will be described later with reference to FIG. 7, the main site disaster support pattern table 33 stores information regarding the disaster situation of the volume and the recovery pattern.

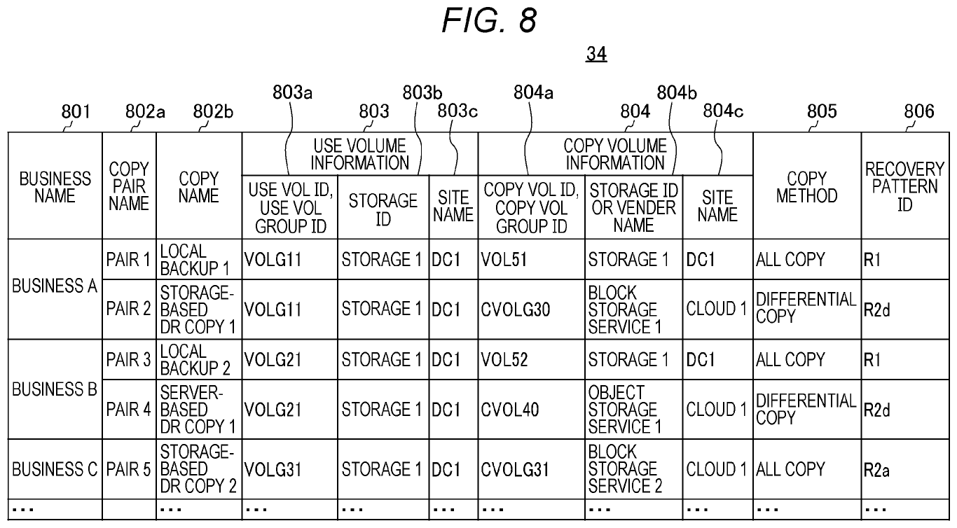

Although details will be described later with reference to FIG. 8, the copy configuration table 34 stores information regarding the volume of the copy with respect to the volume. The copy configuration table 34 is copy configuration information that stores, in association with one another, a business name (business specifying information) specifying business, information of a use volume used in business, and information of a copy volume, which is a copy of the use volume.

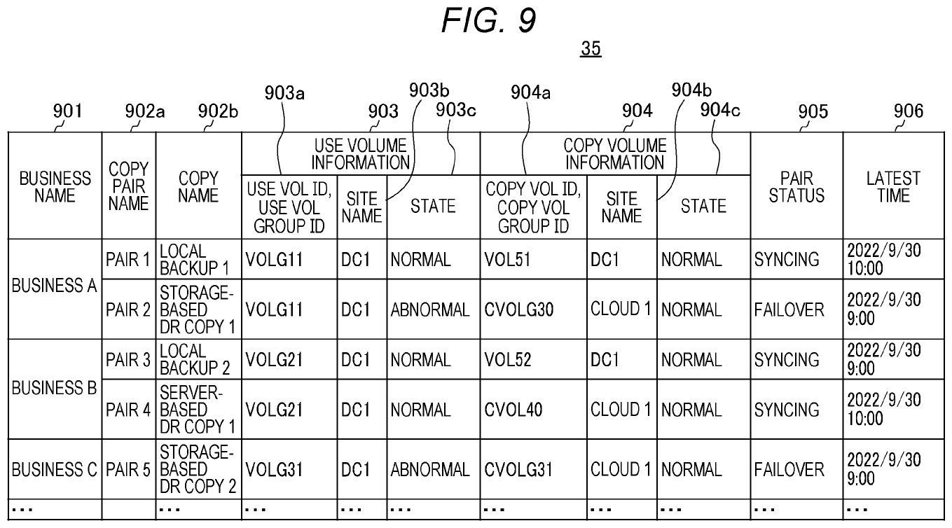

Although details will be described later with reference to FIG. 9, the copy status table 35 stores information regarding the volume and the state of the volume of the copy.

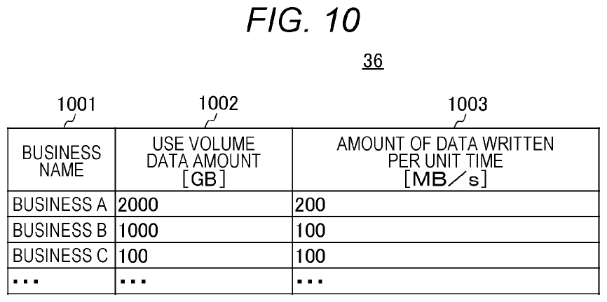

Although details will be described later with reference to FIG. 10, the business data use status table 36 stores information regarding the use status of data used in business.

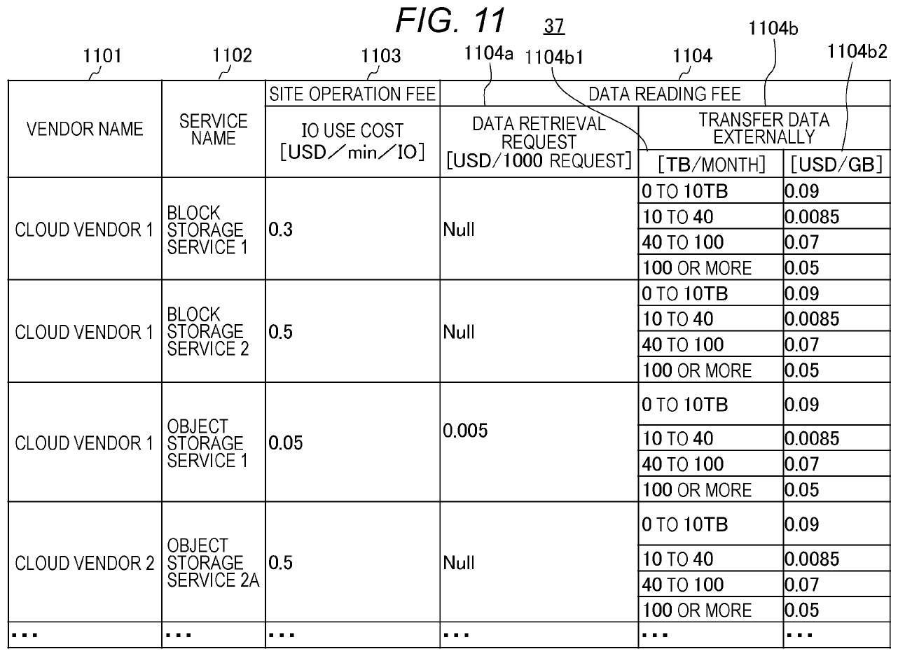

Although details will be described later with reference to FIG. 11, the public cloud cost table 37 stores information on the cost required for using the volume of the site in a cloud environment.

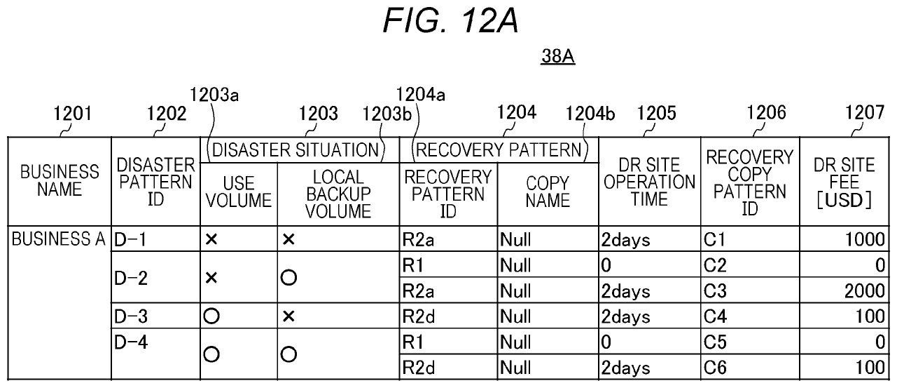

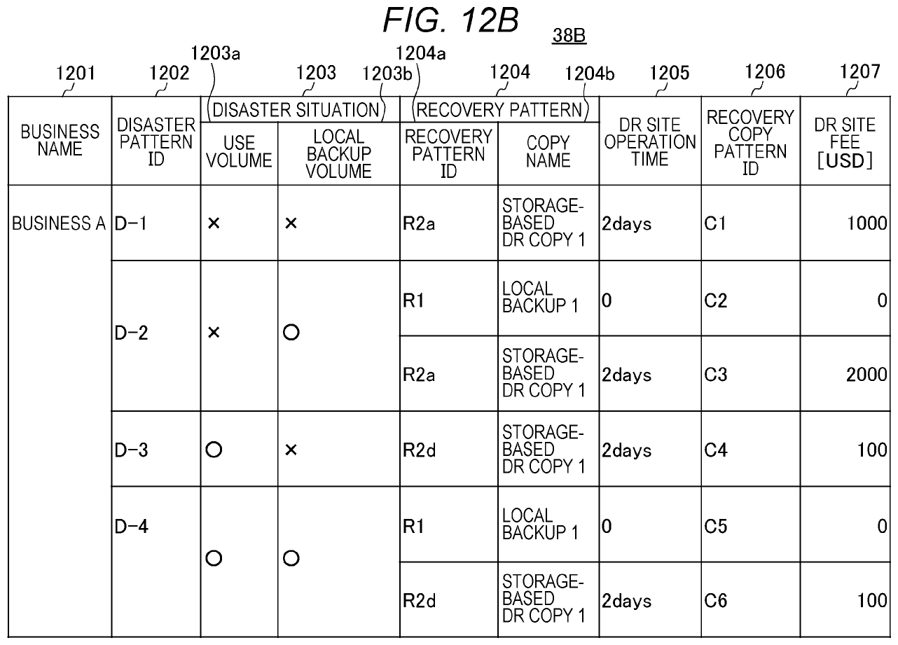

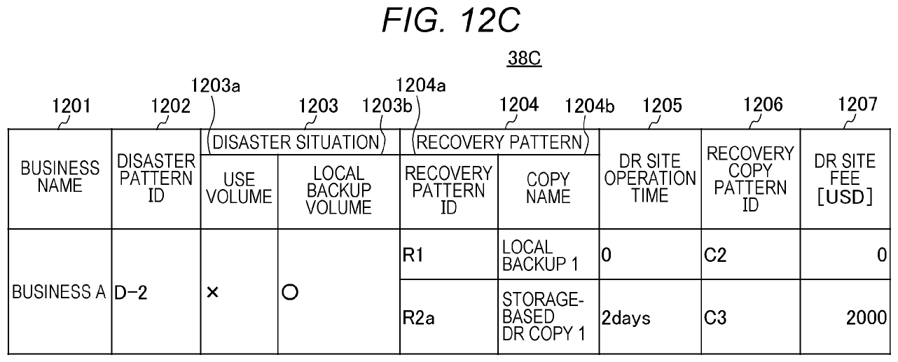

Although details will be described later with reference to FIGS. 12A to 12C, the disaster support cost table 38 (the disaster support cost tables 38A to 38C) stores information regarding the use fee of the DR site in the cloud environment during the recovery time required for data recovery in which data is copied in a set of volume copies.

The input apparatus 24 is a device that receives a user's operation such as a keyboard or a mouse, and acquires information input by the user's operation. The output apparatus 25 is a device that outputs information, such as a display, and presents information to the user by display on a screen, for example. Note that the data management apparatus 1 may include a touchscreen that serves as both the input apparatus 24 and the output apparatus 25.

The network I/F 26 is an interface (transmission/reception device) that can transmit/receive data to/from devices such as the on-premises system 100 and the cloud site 200 via the network NW. The data management apparatus 1 can transmit/receive data to/from devices such as the on-premises system 100 and the cloud site 200 connected to the network NW using the network I/F 26.

Similarly to the data management apparatus 1, the host device 110 and the user terminal 500 can be implemented by a general information processing apparatus such as a PC or a server computer, for example.

### <Various Data Structures>

Next, the data configuration of various data used in the data management apparatus 1 will be described with reference to FIGS. 5 to 12C. Note that the configurations of the fields of the volume group table 31, the service level management table 32, the main site disaster support pattern table 33, the copy configuration table 34, the copy status table 35, the business data use status table 36, the public cloud cost table 37, and the disaster support cost table 38 (the disaster support cost table 38A to the disaster support cost table 38C) described in FIGS. 5 to 12C and below are examples and can be changed as appropriate.

FIG. 5 is a diagram illustrating an example of the data configuration of the volume group table 31. The volume group table 31 illustrated in FIG. 5 stores records having a volume group name 501 and a volume ID 502 as fields.

The volume group name 501 is a field for storing the name of a volume group. The volume ID 502 is a field for storing the ID of a volume belonging to the volume group of the volume group name 501.

FIG. 6 is a diagram illustrating an example of the data configuration of the service level management table 32. The service level management table 32 illustrated in FIG. 6 stores records having a business name 601, an importance 602, a recovery point objective RPO 603, a recovery time objective RTO 604 of the business, and a recovery time objective 605 of the system as fields. The business name 601 is a field for storing the name of the business. The importance 602 is a field for storing the importance of the business of the business name 601.

The recovery point objective RPO 603 is a field for storing a recovery point objective (RPO) when a volume (referred to as use volume) used in the business having the business name 601 is damaged.

The recovery time objective RTO 604 of the business is a field for storing a recovery time objective (RTO) when the use volume used in the business of the business name 601 is damaged.

The recovery time objective 605 of the system is a field for storing a recovery time objective of the system when the use volume used in the business of the business name 601 is damaged.

FIG. 7 is a diagram illustrating an example of the data configuration of the main site disaster support pattern table 33. The main site disaster support pattern table 33 illustrated in FIG. 7 stores records having a disaster pattern ID 701, a disaster situation 702, and a recovery pattern 703 as fields.

The disaster pattern ID 701 is a field for storing the ID of a disaster pattern.

The disaster situation 702 is a field for storing information on the use volume and the disaster state of the local backup volume. The disaster situation 702 includes fields of a use volume 702a and a local backup volume 702b. The values of the use volume 702a and the local backup volume 702b are a value “O” when the volume is not damaged by the disaster and is normal, and a value “X” when the volume is damaged by the disaster and is abnormal.

The recovery pattern 703 is a field for storing information of the recovery pattern. The recovery pattern 703 includes fields of a recovery pattern ID 703a, a location 703b of a copy volume used for recovery, and a copy method 703c. The recovery pattern ID 703a is a field for storing the ID of the recovery pattern. The location 703b of the copy volume used for recovery is a field for storing the location of the copy volume used for recovery. The copy method 703c is a field for storing the copy method.

FIG. 8 is a diagram illustrating an example of the data configuration of the copy configuration table 34. The copy configuration table 34 illustrated in FIG. 8 stores records having a business name 801, a copy pair name 802a, a copy name 802b, use volume information 803, copy volume information 804, a copy method 805, and a recovery pattern ID 806 as fields.

The business name 801 is a field for storing the name of the business. The copy pair name 802a is a field for storing the name of a pair of copies of the volume in data recovery. The copy name 802b is a field for storing the name of a copy of the volume in data recovery.

The use volume information 803 is a field for storing information regarding the use volume. The use volume information 803 includes fields of a use volume ID, a use volume group ID 803a, a storage ID 803b, and a site name 803c. The use volume ID and the use volume group ID 803a are fields for storing the ID of the use volume or the ID of the use volume group. The use volume group is a volume group including a plurality of use volumes. The storage ID 803b is an ID of a storage in which a use volume is created. The site name 803c is the name of a site where the use volume is created.

The copy volume information 804 is a field for storing information regarding a copy volume. The copy volume information 804 includes fields of a copy volume ID, a copy volume group ID 804a, a storage ID or a vendor name 804b, and a site name 804c. The copy volume ID and the copy volume group ID 804a are fields for storing an ID of a copy volume or an ID of a copy volume group. The copy volume group is a volume group including a plurality of copy volumes. The storage ID 804b is the ID of a storage in which a copy volume is created. The site name 804c is the name of a site where a copy volume is created.

The copy method 805 is a field for storing a data copy method in recovery. The recovery pattern ID 806 is a field for storing the ID of the recovery pattern.

FIG. 9 is a diagram illustrating an example of the data configuration of the copy status table 35. The copy status table 35 illustrated in FIG. 9 stores records having a business name 901, a copy pair name 902a, a copy name 902b, use volume information 903, copy volume information 904, a pair status 905, and a latest time 906 as fields.

The business name 901 is a field for storing the name of the business. The copy pair name 902a is a field for storing the name of a copy pair (a pair of volume of copy source and volume of copy destination) in data recovery of the volume. The copy name 902b is a field for storing the name of a copy in data recovery.

The use volume information 903 is a field for storing information regarding the use volume. The use volume information 903 includes fields of a use volume ID, a use volume group ID 903a, a site name 903b, and a state 903c. The use volume ID and the use volume group ID 903a are fields for storing the ID of the use volume or the ID of the use volume group. The site name 903b is the name of a site where the use volume is created. The state 903c is a field for storing the state of the use volume. When the use volume is normal, the value of the state 903c is “normal”. When the use volume is abnormal due to some cause such as being damaged by a disaster, the value of the state 903c is “abnormal”.

The copy volume information 904 is a field for storing information regarding a copy volume. The copy volume information 904 includes fields of a copy volume ID, a copy volume group ID 904a, a site name 904b, and a state 904c.

The copy volume ID and the copy volume group ID 904a are fields for storing the ID of a copy volume or the ID of a copy volume group. The site name 904b is the name of a site where a copy volume is created. The state 904c is a field for storing the state of a copy volume. When the copy volume is normal, the value of the state 904c is “normal”. When the copy volume is abnormal due to some cause such as being damaged by a disaster, the value of the state 904c is “abnormal”.

The pair status 905 is a field for storing the state of a pair of a use volume and a copy volume. The value of the pair status 905 includes “syncing” indicating synchronizing in the copy processing and a value “failover” indicating the state of failover in which there is an abnormality in the use volume and the copy volume is used.

The latest time 906 is a field for storing the time when the copy is performed most recently. The value of the state 903c of the use volume information 903, the value of the state 904c of the copy volume information 904, and the value of the pair status 905 are values at the latest time 906.

FIG. 10 is a diagram illustrating an example of the data configuration of the business data use status table 36. The business data use status table 36 illustrated in FIG. 10 stores records having a business name 1001, a use volume data amount 1002, and an amount 1003 of data written per unit time as fields.

The business name 1001 is a field for storing the name of the business. The use volume data amount 1002 is a field for storing the amount of data used in the business of the business name 1001 (the total amount of data stored in the use volume). The amount 1003 of data written per unit time is a field for storing the amount of data written per unit time in the business of the business name 1001.

FIG. 11 is a diagram illustrating an example of the data configuration of the public cloud cost table 37. The public cloud cost table 37 illustrated in FIG. 11 stores records including a vendor name 1101, a service name 1102, a site operation fee 1103, and a data reading cost 1104 as fields.

The vendor name 1101 is a field for storing the name of a vendor of the cloud. The service name 1102 is a field for storing a service name of the cloud.

The site operation fee 1103 is a field for storing the cloud site operation fee.

The data reading cost 1104 is a field for storing a cost required for reading data from the cloud site. The data reading cost 1104 includes fields of a data retrieval request 1104a and external data transfer 1104b. The data retrieval request 1104a is a field for storing the cost required for a data retrieval request.

The external data transfer 1104b is a field for storing the cost required for reading data and transferring the data to the outside of the cloud site. The external data transfer 1104b includes fields of a data amount range 1104b1 and a data transfer fee 1104b2. The data transfer fee 1104b2 is a field for storing the data transfer fee per unit data amount.

FIGS. 12A to 12C are diagrams illustrating examples of the data configurations of the disaster support cost table 38A to the disaster support cost table 38C. The disaster support cost table 38A illustrated in FIG. 12A is the disaster support cost table 38 created when the operation phase is “pre-operation”. The disaster support cost table 38B illustrated in FIG. 12B is the disaster support cost table 38 created when the operation phase is “in-operation normal time”. The disaster support cost table 38C illustrated in FIG. 12C is the disaster support cost table 38 created when the operation phase is “in-operation disaster”.

The disaster support cost table 38A to the disaster support cost table 38C illustrated in FIGS. 12A to 12C store records having a business name 1201, a disaster pattern ID 1202, a disaster situation 1203, a recovery pattern 1204, a DR site operation time 1205, a recovery copy pattern ID 1206, and a DR site use fee 1207 as fields.

The business name 1201 is a field for storing the name of the business. The disaster pattern ID 1202 is a field for storing the ID of a disaster pattern. As described above with reference to FIG. 3, the recovery pattern ID indicates a set of volume copies of the volume of the disaster target and the copy volume storing data to be copied to the volume of the disaster target in the support to the disaster pattern.

The disaster situation 1203 is a field for storing information on the use volume and the disaster state of the local backup volume. The disaster situation 1203 includes fields of a use volume 1203a and a local backup volume 1203b. The values of the use volume 1203a and the local backup volume 1203b are a value “O” when the volume is not damaged by the disaster and is normal, and a value “X” when the volume is damaged by the disaster and is abnormal.

The recovery pattern 1204 is a field for storing information regarding the recovery pattern. The recovery pattern 1204 includes fields of a recovery pattern ID 1204a and a copy name 1204b. The recovery pattern ID 1204a is a field for storing the ID of the recovery pattern. The copy name 1204b is a field for storing the name of a copy of the volume in data recovery.

The DR site operation time 1205 is a field for storing a time (recovery time) required to recovery of data using the cloud DR copy volume of the cloud site.

The recovery copy pattern ID 1206 is a field for storing the ID for identifying a set of a volume to be recovered and a copy volume storing data to be copied to the volume to be recovered.

The DR site use fee 1207 is a field for storing a use fee of a cloud site (a DR site in a cloud environment) for data recovery during the recovery time required for data recovery in which data is copied in a set of volume copies. Here, the use fee of the cloud site for data recovery includes the following two use fees.
1. A use fee of the cloud DR copy volume 221 for use as an alternative for the use volume 121 in the on-premises environment when the use volume 121 in the on-premises environment is damaged, and a use fee of the alternative host device 210 that takes over the function of the host device 110.
2. A use fee of the cloud DR copy volume 221 for reading data from the cloud DR copy volume 221 while data is copied from the cloud DR copy volume 221 to the use volume 121 in the on-premises environment.

The value of the use fee 1207 of the DR site may be a cloud use fee calculation expression corresponding to the recovery copy pattern 1206. The value of the use fee calculated for each copy pair, which is the value of the use fee 1207 of the DR site, may be managed as data separate from the disaster support cost table 38A to the disaster support cost table 38C.

The main site disaster support pattern table 33 is main site disaster support pattern information in which the disaster situation of a volume in a use site where the use volume is created is associated with presence or absence of use of a DR site in the cloud environment for the data recovery.

The public cloud cost table 37 is cloud cost information storing, in association with each other, a site in a cloud environment and information on a cost required to use the volume of the site in the cloud environment.

### <Processing Procedure>

Next, the processing procedure of the data management apparatus 1 will be described. The data management apparatus 1 displays a monitor (output apparatus 25) cost analysis screen. As described below, the cost analysis screen is a screen that displays an analysis condition and an analysis result for the analysis of a cost in a case of recovering from damage of the volume related to the business.

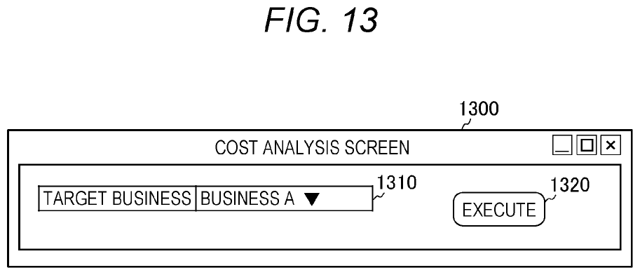

FIG. 13 is an explanatory diagram explaining an example of a cost analysis screen 1300 displayed on the output apparatus 25 (monitor) of the data management apparatus 1. The cost analysis screen 1300 illustrated in FIG. 13 includes a business selection button 1310 used to input the name of a business and an analysis execution button 1620.

When pressed, the business selection button 1310 displays a list of business names so that the business of an analysis target (referred to as “target business”) can be selected.

When the analysis execution button 1320 is clicked, the DR operation phase determination unit 11 of the data management apparatus 1 executes the DR operation phase determination processing with the business name (target business name) input using the business selection button 1310 as an input.

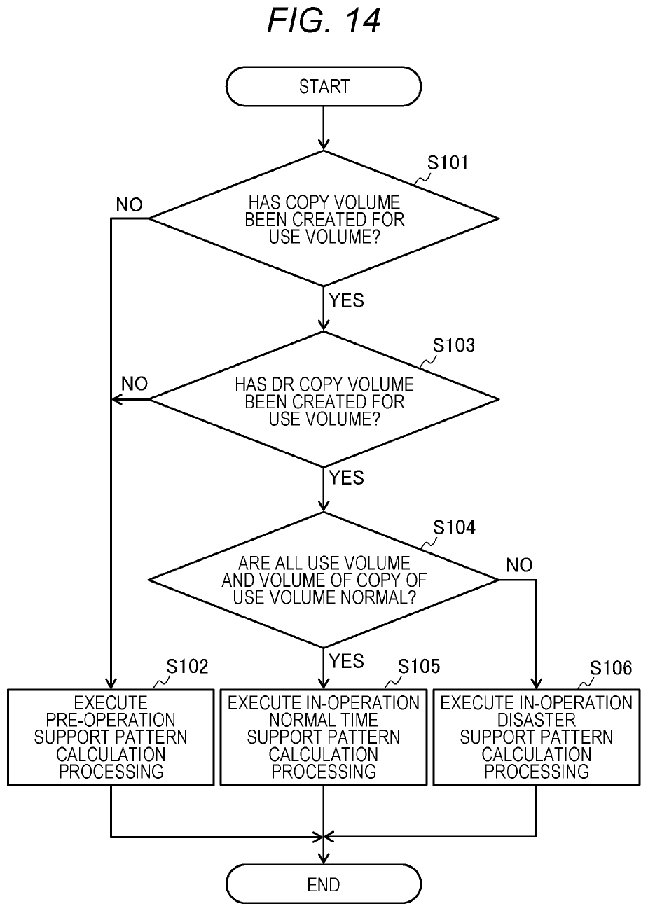

### <1, DR Operation Phase Determination Processing, FIG. 14>

FIG. 14 is a flowchart showing an example of the DR operation phase determination processing of the example. With the business of the business name input using the cost analysis screen 1300 (see FIG. 13) as a target business, the DR operation phase determination unit 11 of the data management apparatus 1 calculates an operation phase of a use volume used in the target business. Here, the business name is target business specifying information for specifying the target business. The target business specifying information only needs to be information that can specify the target business, and for example, an ID of the business may be used other than the business name. When the ID of the business is used as the target business specifying information, the ID of the business may be input using the cost analysis screen 1300, and the DR operation phase determination processing may be performed using the ID of the business as an input.

With reference to the copy configuration table 34, the data management apparatus 1 determines whether or not volumes of copies have been created for all the use volumes used in the target business (step S101). When it is determined that the volume of the copy has not been created for the use volume used in the target business (step S101: No), the process proceeds to step S102 and the pre-operation support pattern calculation processing is executed. On the other hand, when it is determined that the volume of the copy has been created for the use volume used in the target business (step S101: Yes), the process proceeds to step S103.

The copy configuration table 34 stores, in association with one another, the business name, the use volume ID or the use volume group ID (the use volume ID of the use volume information 803 or the use volume group ID 803a) of the use volume used in the business of the business name, and the copy volume ID or the copy volume group ID (the copy volume ID of the copy volume information 804 and the copy volume group ID 804a) of the volume of the copy for the use volume. When the copy configuration table 34 does not have a record storing the target business name, there is no volume of the copy for the use volume, and thus, the cloud DR copy volume of the DR site in the cloud environment for the use volume has not been created. Therefore, when the copy configuration table 34 does not have a record storing the target business name, the operation phase for the use volume of the target business is “pre-operation”.

Therefore, the data management apparatus 1 determines whether or not the copy configuration table 34 has a record storing the target business name. When the copy configuration table 34 has a record storing the target business name, the data management apparatus 1 determines that the volume of the copy for the use volume used in the target business has been created (step S101: Yes). On the other hand, when the copy configuration table 34 does not have a record storing the target business name, the data management apparatus 1 determines that the volume of copy for the use volume used in the target business has not been created (step S101: No).

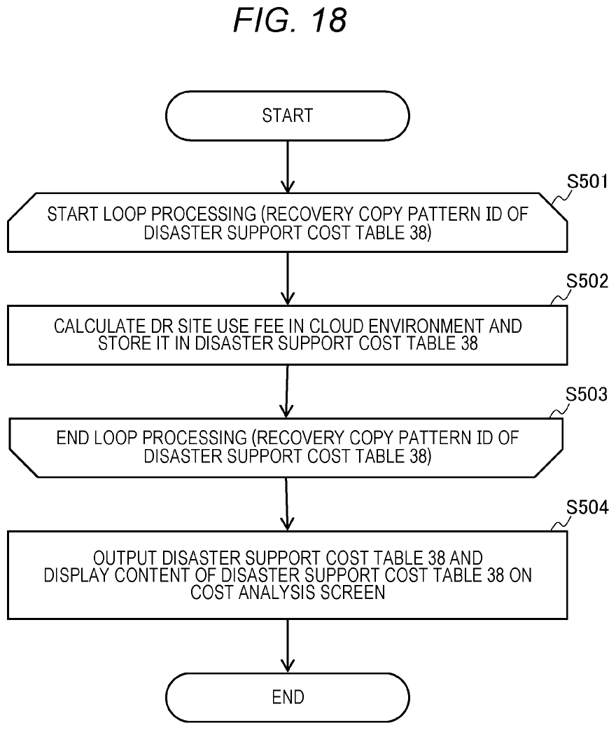

Next, the data management apparatus 1 executes the pre-operation support pattern calculation processing (see FIG. 18) with the target business name and the value “pre-operation” of the operation phase as inputs (step S102).

Next, with reference to the copy configuration table 34, the data management apparatus 1 determines whether or not the cloud DR copy volumes for all the use volumes have been created (step S103). When it is determined that the cloud DR copy volumes for all the use volumes have not been created (step S103: No), the process proceeds to step S102, and the pre-operation support pattern calculation processing is executed. On the other hand, when it is determined that the cloud DR copy volumes for all the use volumes have been created (step S103: Yes), the process proceeds to step S104.

In a record storing the target business name of the copy configuration table 34, when the cloud DR copy volume of the DR site in the cloud environment is associated with all the use volumes, the cloud DR copy volumes for all the use volumes have been created. Therefore, when the site name of the cloud site is stored in the site name 804c of the copy volume information 804 for all the use volume IDs or the use volume group IDs (the use volume ID of the use volume information 803 and the use volume group ID 803a) in the record storing the target business name of the copy configuration table 34, the data management apparatus 1 determines that the cloud DR copy volumes for all the use volumes have been created (step S103: Yes).

On the other hand, when the site name of the cloud site is not stored in the site name 804c of the copy volume information 804 for at least one use volume ID or use volume group ID (the use volume ID of the use volume information 803 and the use volume group ID 803a) in the record storing the target business name of the copy configuration table 34, the data management apparatus 1 determines that the cloud DR copy volumes for all the use volumes are not created (step S103: No). In this case, since the cloud DR copy volume has not been created for at least one use volume, the pre-operation support pattern calculation processing is executed in step S102.

Next, with reference to the copy status table 35, the data management apparatus 1 determines whether or not the use volume and the volume of the copy of the use volume are all normal (step S104). When it is determined that the use volume and the volume of the copy of the use volume are all normal (step S104: Yes), the process proceeds to step S105 and the in-operation normal time support pattern calculation processing is executed. On the other hand, when it is determined that at least one of the use volume and the volume of the copy of the use volume is not normal (step S104: No), the process proceeds to step S106 and the in-operation disaster support pattern calculation processing is executed.

Here, the state 903c of the use volume information 903 of the copy status table 35 stores information on whether or not the state of the use volume is normal. The state 904c of the copy volume information 904 of the copy table 35 stores information on whether or not the state of the copy volume with respect to the use volume is normal.

Therefore, when all the values of the state 903c of the use volume information 903 are “normal” and all the values of the state 904c of the copy volume information 904 are “normal” in the record storing the target business name of the copy status table 35, the data management apparatus 1 determines that all the use volumes and the volumes of the copy of the use volumes are normal (step S104: Yes). On the other hand, when at least one value of the state 903c of the use volume information 903 and the state 904c of the copy volume information 904 is “abnormal” in the record storing the target business name of the copy status table 35, the data management apparatus 1 determines that at least one volume of the use volume and the volume of the copy of the use volume is not normal (step S104: No).

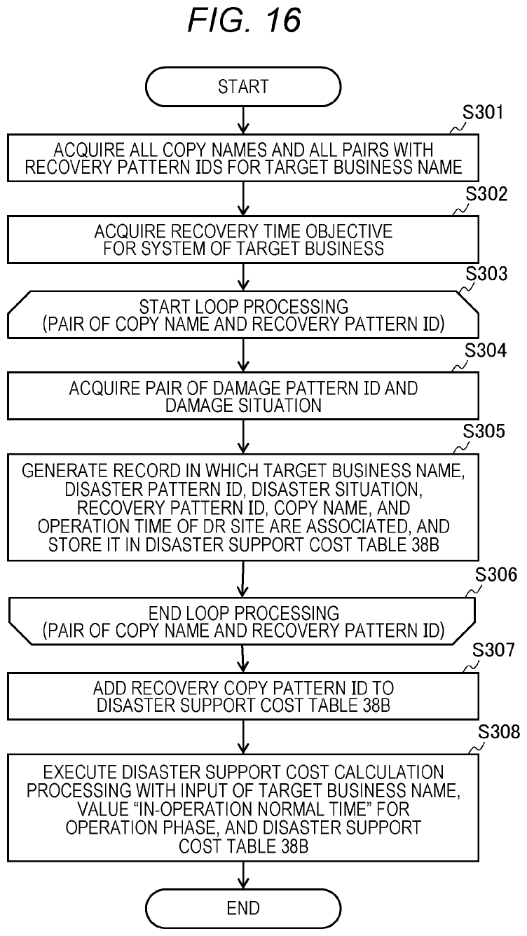

Next, the data management apparatus 1 executes the in-operation normal time support pattern calculation processing (see FIG. 16) with the target business name and the value “in-operation normal time” of the operation phase as inputs, and ends the processing (step S105).

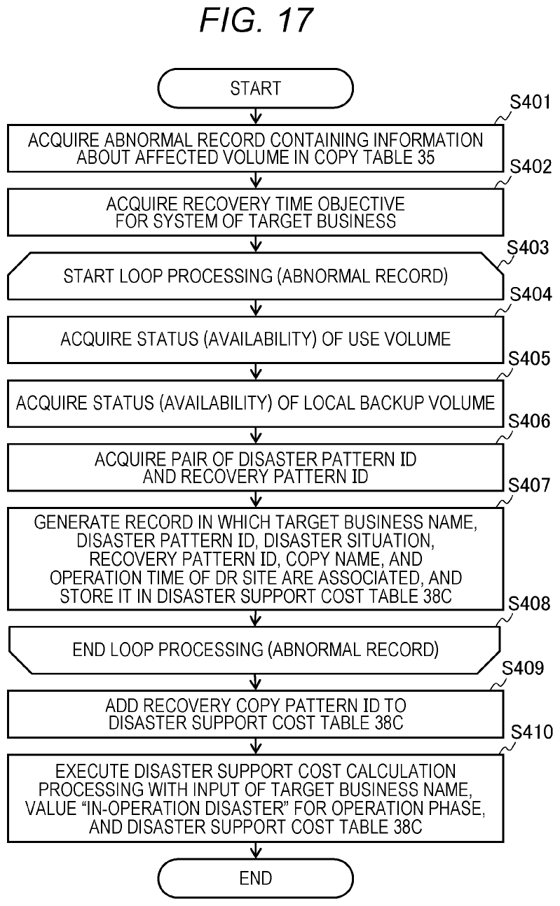

Next, the data management apparatus 1 executes the in-operation disaster support pattern calculation processing (see FIG. 17) with the target business name and the value “in-operation disaster” of the operation phase as inputs, and ends the processing (step S106).

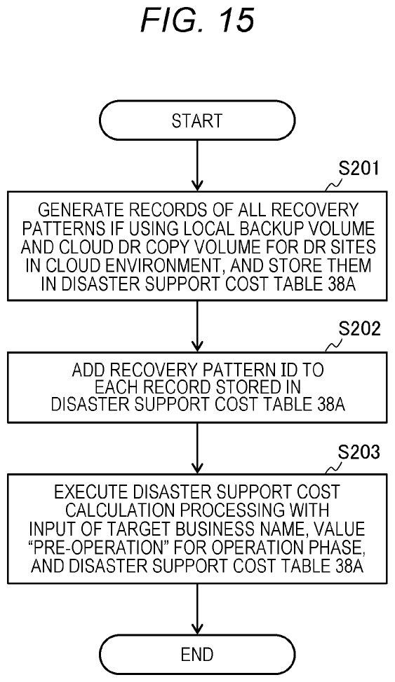

### <2, Pre-Operation Support Pattern Calculation Processing, FIG. 15>

FIG. 15 is a flowchart showing an example of the pre-operation support pattern calculation processing. The pre-operation support pattern calculation unit 12 of the data management apparatus 1 executes the pre-operation support pattern calculation processing with the target business name and the value “pre-operation” of the operation phase as inputs.

Using the main site disaster support pattern table 33, the data management apparatus 1 generates and stores, into the disaster support cost table 38A (see FIG. 12A), records of all recovery patterns in a temporary case of using the local backup volume and the cloud DR copy volume of the DR site in the cloud environment (step S201). The data management apparatus 1 generates and stores a record in which the target business name, a copy name “Null”, and a value of the DR site operation time are associated with each record of the main site disaster support pattern table 33.

Here, when the value of the recovery pattern ID is “R1”, the value of the cloud DR site operation time is set to “0”. This is because in this case, the copy volume for reading data in the data recovery is created in the local site, and the cloud DR copy volume in the cloud site is not used for the data recovery. On the other hand, when the value of the recovery pattern ID is “R2a” or “R2d”, in the service level management table 32, the value of the recovery time objective 605 of the system in the record where the business name 601 is the target business name is set as the value of the DR site operation time. Here, it is assumed that it takes time of the recovery time objective 605 of the system to recover the data.

Next, in step S201, the data management apparatus 1 assigns recovery copy pattern IDs to all the stored records in order of the created records (step S202). Here, the values of the recovery copy pattern IDs are C1, C2, . . . , and Cn. The value of the recovery copy pattern ID is a value obtained by combining “C” and a number (order of creating the record).

Next, the data management apparatus 1 executes the disaster support cost calculation processing (see FIG. 18) with the target business name, the value “pre-operation” of the operation phase, and the disaster support cost table 38A as inputs, and ends the processing (step S203).

### <3, In-Operation Normal Time Support Pattern Calculation Processing, FIG. 16>

FIG. 16 is a flowchart showing an example of the in-operation normal time support pattern calculation processing. The in-operation normal time support pattern calculation unit 13 of the data management apparatus 1 executes the in-operation normal time support pattern calculation processing with the target business name and the value “in-operation normal time” of the operation phase as inputs.

The data management apparatus 1 acquires and stores all sets of the copy name 802b in the copy pair name 802a and the recovery pattern ID 806 from the record storing the target business name of the copy configuration table 34 (step S301). Here, when the recovery pattern ID 806 is R2d (differential copy), it is assumed that the differential management does not function depending on the disaster situation and the differential copy cannot be performed, and therefore, the data management apparatus 1 generates and stores these two sets in which a set of the copy name 802 that is all copy and the value “R2a” of the recovery pattern ID 806 is added to a set of the copy name 802 and the value “R2d” of the recovery pattern ID 806.

Next, the data management apparatus 1 acquires the value of the recovery time objective 605 of the system in the record in which the business name 601 is the target business name in the service level management table 32, and stores the value as the value of the DR site operation time when the value of the recovery pattern ID is “R2a” or “R2d” (step S302).

Next, the data management apparatus 1 starts loop processing of generating and storing, into the disaster support cost table 38B, records of the recovery patterns for all sets of the copy names and the values of the recovery pattern IDs stored in step S301 (step S303). The processing shown between step S303 of the loop start and step S306 of the loop end is repeatedly performed for each set of the copy name stored in step S301 and the value of the recovery pattern ID. In step S303, the data management apparatus 1 selects a set of one copy name and the value of the recovery pattern ID from sets of unprocessed copy names and the values of the recovery pattern IDs among all the sets of the copy names and the values of the recovery pattern IDs stored in step S301.

Next, the data management apparatus 1 acquires and stores a set of the disaster pattern ID 701 associated with the value of the recovery pattern ID selected in step S303 and the disaster situation 702 (including the value of the use volume 702a and the value of the local backup volume 702b) in the main site disaster support pattern table 33 (step S304).

Next, the data management apparatus 1 generates and stores, into the disaster support cost table 38B (see FIG. 12B), a record in which the target business name, the disaster pattern ID stored in step S304, the disaster situation stored in step S304, the value of the recovery pattern ID and the copy name selected in step S303, and the value of the operation time of the DR site are associated with one another (step S305).

Here, when the value of the recovery pattern ID is “R1”, the value of the DR site operation time is set to “0”. This is because in this case, the copy volume for reading data in the data recovery is created in the local site, and the cloud DR copy volume in the cloud site is not used for the data recovery. On the other hand, when the value of the recovery pattern ID is “R2a” or “R2d”, the value of the “recovery time objective of the system” stored in step S302 is set as the value of the DR site operation time.

When a generated record is stored in the disaster support cost table 38B, in a case where a record having the same set of the disaster pattern ID and the disaster situation is already stored in the disaster support cost table 38B, the data management apparatus 1 adds information of the record to be stored in step S305 to the record in which the set of the disaster pattern ID and the disaster situation is already stored.

Next, the data management apparatus 1 determines whether or not the processing has been completed for all sets of copy names and values of the recovery pattern IDs stored in step S301 (step S306). If the data management apparatus 1 determines in step S306 that the processing has not been completed for all the sets of the copy names and the values of the recovery pattern IDs stored in step S301, the data management apparatus 1 returns to step S303 and continues the processing. On the other hand, if the data management apparatus 1 determines that the process has been completed for all the sets of the copy names and the values of the recovery pattern IDs stored in step S301, the data management apparatus 1 executes the processing of step S307.

Next, in step S307, the data management apparatus 1 assigns recovery copy pattern IDs to all the records stored in the disaster support cost table 38B in descending order of the records (step S307). Here, the values of the recovery copy pattern IDs are C1, C2, . . . , and Cn, and is a value obtained by combining “C” and a number (an order at a position above the record).

Next, the data management apparatus 1 executes the disaster support cost calculation processing (see FIG. 18) with the target business name, the value “in-operation normal time” of the operation phase, and the disaster support cost table 38B as inputs, and ends the processing (step S308).

### <4, In-Operation Disaster Support Pattern Calculation Processing, FIG. 17>

FIG. 17 is a flowchart showing an example of the in-operation disaster support pattern calculation processing. The in-operation disaster support pattern calculation unit 14 of the data management apparatus 1 executes the in-operation disaster support pattern calculation processing with the target business name and the value “in-operation disaster” of the operation phase as inputs.

In the copy status table 35, among records associated with the target business name, the data management apparatus 1 stores, as an abnormal record, a record in which the value of the state 903c of the use volume information 903 is “abnormal” or the value of the pair status 905 is “abnormal” or “failover” (step S401). When the operation monitoring program 18a detects an abnormality such as abnormal termination of copying of the record associated with the target business name in the copy status table 35, it is determined as an abnormality and stored as an abnormal record even when the above condition is not satisfied in the copy status table 35.

Next, the data management apparatus 1 acquires the value of the recovery time objective 605 of the system in the record in which the business name 601 is the target business name in the service level management table 32, and stores the value as the value of the DR site operation time when the value of the recovery pattern ID is “R2a” or “R2d” (step S402).

Next, the data management apparatus 1 starts loop processing of generating and storing, into the disaster support cost table 38C, records of the recovery patterns for all abnormal records stored in step S401 (step S403). The processing shown between step S403 of the loop start and step S408 of the loop end is repeatedly performed for each abnormal record stored in step S401. In step S403, the data management apparatus 1 selects one abnormal record from unprocessed abnormal records among all the abnormal records stored in step S401.

Next, the data management apparatus 1 acquires and stores “o” or “x” of the use volume in the disaster situation 1203 of the disaster support cost table 38C for the abnormal record selected in step S403 (step S404). When the value of the state of the use volume information of the abnormal record is “o”, the data management apparatus 1 stores “o” representing normal as the value for the use volume of the abnormal record. For example, an abnormal record due to copy abnormal termination due to a network failure is an example of this “o” because the volume itself is normal. On the other hand, when the value of the state of the use volume information of the abnormal record is “x”, the data management apparatus 1 stores “x” representing abnormality as the value for the use volume of the abnormal record.

Next, the data management apparatus 1 acquires and stores “o” or “x” of the local backup volume in the disaster situation 1203 of the disaster support cost table 38C for the abnormal record selected in step S403 (step S405). When all of the following conditions 1 to 4 are satisfied, the data management apparatus 1 stores “o” as the value for the local backup volume. On the other hand, when at least one of the following conditions 1 to 4 is not satisfied, the data management apparatus 1 stores “x” as the value for the local backup volume.

Condition 1; The site name of the use volume information of the abnormal record is the same as the site name of the copy volume information. That is, the use volume and the copy volume are created in the same site in an on-premises environment.

Condition 2; The value of the state of the copy volume information of the abnormal record is “o”.

Condition 3; The following expression is satisfied. When this expression is satisfied, as for the use volume, sufficiently new (within the recovery point objective RPO) data is copied to the local backup volume.

Current time—Latest time of copy in corresponding (corresponding to abnormal record) copy pair in copy status table 35<Recovery point objective RPO of record storing target business name in service level management table 32

Condition 4; The value of the pair status of the abnormal record is not “failover”. This is because when the value of the pair status is “failover”, it is assumed that an alternative operation has already been executed in the DR site and recovery by the local backup is not performed.

Next, in the main site disaster support pattern table 33, the data management apparatus 1 calculates and stores the value of the disaster situation including the value for the use volume of the abnormal record acquired in step S404 and the value of the local backup volume for the abnormal record acquired in step S405, and acquires and stores a set of the disaster pattern ID and the recovery pattern ID associated with the value of the disaster situation having been stored (step S406).

Then, the data management apparatus 1 acquires and stores a set of the disaster pattern ID and the recovery pattern ID associated with the value (set of the value of the use volume and the value of the local backup volume) of the disaster situation calculated as described above in the main site disaster support pattern table 33.

Next, the data management apparatus 1 generates and stores, into the disaster support cost table 38C (see FIG. 12C), a record in which the target business name, the disaster situation, the disaster pattern ID, the recovery pattern ID that are stored in step S406, the copy name of the abnormal record, and the value of the operation time of the DR site are associated with one another (step S407).

Here, when the value of the recovery pattern ID is “R1”, the value of the DR site operation time is set to “0”. This is because in this case, the copy volume for reading data in the data recovery is created in the local site, and the cloud DR copy volume in the cloud site is not used for the data recovery. On the other hand, when the value of the recovery pattern ID is “R2a” or “R2d”, the value of the recovery time objective stored in step S402 is set as the value of the DR site operation time.

When a generated record is stored in the disaster support cost table 38C, in a case where a record having the same set of the disaster pattern ID and the disaster situation is already stored in the disaster support cost table 38C, the data management apparatus 1 adds information of the record to be stored in step S407 to the record in which the set of the disaster pattern ID and the disaster situation is already stored.

Next, the data management apparatus 1 determines whether or not the processing has been completed for all the abnormal records stored in step S401 (step S408). If the data management 1 determines in step S408 that the processing has not been completed for all the abnormal records stored in step S401, the data management apparatus 1 returns to step S403 and continues the processing. On the other hand, if the data management apparatus 1 determines that the processing has been completed for all the abnormal records stored in step S401, the data management apparatus 1 executes the processing of step S409.

Next, in step S407, the data management apparatus 1 assigns recovery copy pattern IDs to all the records stored in the disaster support cost table 38C in descending order of the records (step S409). Here, the values of the recovery copy pattern IDs are C1, C2, . . . , and Cn, and is a value obtained by combining “C” and a number (an order at a position above the record).

Next, the data management apparatus 1 executes the disaster support cost calculation processing (see FIG. 17) with the target business name, the value “in-operation disaster” of the operation phase, and the disaster support cost table 38C as inputs, and ends the processing (step S410).

### <5, Disaster Support Cost Calculation Processing, FIG. 18>

FIG. 18 is a flowchart showing an example of the disaster support cost calculation processing. The disaster support cost calculation unit 15 of the data management apparatus 1 executes the disaster support cost calculation processing with the target business name, the value (“pre-operation”, “in-operation normal time”, “in-operation disaster”) of the operation phase, and the disaster support cost table 38 (one of the disaster support cost tables 38A to 38C) as inputs.

The data management apparatus 1 starts loop processing of calculating the use fee of the DR site in the cloud environment for the recovery copy pattern ID stored in the disaster support cost table 38 (one of the disaster support cost tables 38A to 38C) of input (step S501). The processing shown between step S501 of loop start for calculating the use fee of the DR site in the cloud environment and step S503 of loop end for the recovery copy pattern ID stored in the disaster support cost table 38 (one of the disaster support cost tables 38A to 38C) of input is repeatedly performed for each record storing the recovery copy pattern ID stored in the disaster support cost table 38 (one of the disaster support cost tables 38A to 38C). In step S501, the data management apparatus 1 selects one recovery copy pattern ID from the recovery copy pattern IDs stored in the disaster support cost table 38 (one of the disaster support cost tables 38A to 38C).

Next, the data management apparatus 1 calculates and stores the use fee of the DR site in the cloud environment of the record storing the recovery copy pattern ID selected in step S501 (step S502). The data management apparatus 1 calculates the use fee of the DR site in the cloud environment as in the following calculation method 1 to 3 in accordance with the recovery pattern ID of the record storing the recovery copy pattern ID selected in step S501, and adds the calculated use fee of the DR site in the cloud environment to the record storing the recovery copy pattern ID selected in step S501 of the disaster support cost table 38 (one of the disaster support cost tables 38A to 38C).

Calculation method 1; Case where the recovery pattern ID is “R1” (case where a copy volume is created at a local site and all copy is performed). The data management apparatus 1 calculates the use fee of the DR site in the cloud environment as “0”. The copy volume is a volume created in the local site and is not created in the site of the cloud environment. Since the site in the cloud environment is not used for recovery, the use fee of the DR site in the cloud environment is “0”.

Calculation method 2; Case where the recovery pattern ID is “R2a” (case where a cloud DR copy volume is set as a copy volume in a DR site in a cloud environment and all copy is performed). The data management apparatus 1 calculates the use fee of the DR site in the cloud environment as follows.

Use fee of DR site in cloud environment=Operation fee of DR site in cloud environment in recovery time+Data reading cost required for reading data from cloud DR copy volume

The use fee of the DR site in the cloud environment is a use fee of the DR site in the cloud environment from the occurrence of a failure in the disaster pattern calculated by the support pattern calculation unit (the pre-operation support pattern calculation unit 12, the in-operation normal time support pattern calculation unit 13, and the in-operation disaster support pattern calculation unit 14) using cloud cost information to the completion of system recovery of the use site where the use volume is created.

First, the “operation fee of DR site in cloud environment during recovery time” will be described.

Operation fee of DR site in cloud environment during recovery time=DR site operation time×IO use cost

Here, the DR site operation time is a value of the DR site operation time of the record storing the recovery copy pattern ID selected in step S501. The IO use cost is acquired as follows. The data management apparatus 1 acquires a record storing the target business name and the recovery copy pattern ID selected in step S501 in the copy configuration table 34. Then, the data management apparatus 1 acquires the copy pair name and the storage ID of the copy volume information 804 or the vendor name 804b (vendor name) from the acquired record. Then, the data management apparatus 1 acquires a record (hereinafter, “cost record”) storing the acquired storage ID or the vendor name 804b (vendor name) in the public cloud cost table 37. Then, the data management apparatus 1 acquires the value of the site operation fee (IO use cost) 1103 of the cost record as the value of the IO use cost.

Next, the “data reading cost required for reading data from cloud DR copy volume” will be described.

Data reading cost required for reading data from cloud DR copy volume=(volume data amount in use+Data amount written in recovery time)×Data transfer fee per unit data amount

Here, the volume data amount in use is a value of the “use volume data amount” of the record storing the target business name in the business data use status table 36. With reference to the business data use status table 36, the data management apparatus 1 acquires the value of the “volume data amount in use”.

The “amount of data written in the recovery time” is calculated by the following expression.

Amount of data written in recovery time=Operation time of DR site×Amount of written data per unit time

Here, the operation time (the value of the record storing the recovery copy pattern ID selected in step S501) of the DR site is regarded as the recovery time. The amount of data written per unit time is a value of the “amount of data written per unit time” of the record storing the target business name in the business data use status table 36. With reference to the business data use status table 36, the data management apparatus 1 acquires the value of the “amount of data written per unit time”.

The “data transfer fee per unit data amount” is a value of the data transfer fee 1104b2 corresponding to the range 1104b1 including the value of (volume data amount in use+data amount written in recovery time) in the cost record of the public cloud cost table 37. With reference to the cost record in the public cloud cost table 37, the data management apparatus 1 acquires the value of the data transfer fee per unit data amount.

Calculation method 3; Case where the recovery pattern ID is “R2d” (case where the cloud DR copy volume is set as a copy volume in a DR site in a cloud environment and differential copy is performed). The data management apparatus 1 calculates the use fee of the DR site in the cloud environment as follows.

Use fee of DR site in cloud environment=Operation fee of DR site in cloud environment in recovery time+Data reading cost required for reading data from cloud DR copy volume

The “operation fee of DR site in cloud environment during recovery time” is the same as the calculation method of the “operation fee of DR site in cloud environment during recovery time” in the calculation method 2 described above, and thus the description will be omitted.

Next, the “data reading cost required for reading data from cloud DR copy volume” will be described.

Data reading cost required for reading data from cloud DR copy volume=(Data amount written in recovery time)×Data transfer fee per unit data amount

Here, the “data amount written in recovery time” and the “data transfer fee per unit data amount” are the same as the calculation method of the above-described calculation method 2, and thus the description will be omitted.

Next, the data management apparatus 1 determines whether or not the processing has been completed for all the recovery copy pattern IDs stored in the disaster support cost table 38 (one of the disaster support cost tables 38A to 38C) (step S503). If the data management apparatus 1 determines that the processing has not been completed for all the recovery copy pattern IDs, the data management apparatus 1 returns to step S501 and continues the processing. On the other hand, if the data management apparatus 1 determines that the processing has been completed for all the recovery copy pattern IDs, the data management apparatus 1 executes the processing of step S504.

Next, the data management apparatus 1 outputs the disaster support cost table 38 (one of the disaster support cost tables 38A to 38C), and ends the processing (step S504). Here, the data management apparatus 1 outputs, to the output apparatus 25 (monitor), information of the cost analysis screen added with the content of the disaster support cost table 38 (one of the disaster support cost tables 38A to 38C), and presents the user the content of the disaster support cost table 38 (one of the disaster support cost tables 38A to 38C).

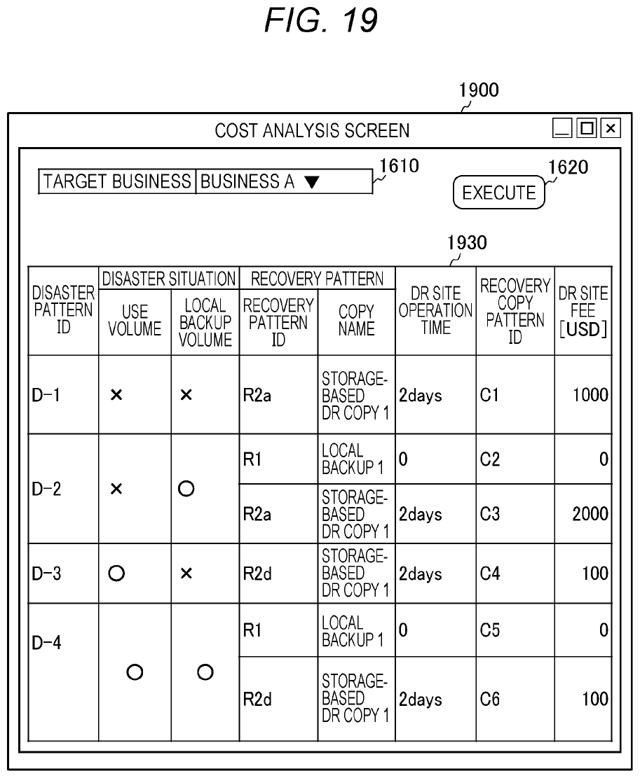

FIG. 19 is an explanatory diagram explaining an example of a cost analysis screen 1900 displayed on the output apparatus 25 (monitor) of the data management apparatus 1. The cost analysis screen 1900 illustrated in FIG. 19 displays a cost list (part of the disaster support cost table 38) 1930.

### Effects of Invention

The DR cost calculation support method of the data management apparatus 1 calculates the use fee of a DR site in a cloud environment from occurrence of a failure in a disaster pattern to completion of system recovery of a use site where a use volume is created. The use fee of the DR site in the cloud environment is the cost at the time of disaster of the volume of the DR site in the virtual environment. In many cases, when operating a DR site, the user judges whether or not to use the volume of a DR site in a virtual environment by using information on the cost of the volume of the DR site in the virtual environment. Then, with reference to the cost at the time of disaster of the volume of the DR site in the virtual environment calculated by the data management apparatus 1, it makes it easier for the user to more appropriately judge whether or not to use the volume of the DR site in the virtual environment. Therefore, the data management apparatus 1 and the DR cost calculation support method of the data management apparatus 1 support the operation of the DR site by calculating the use fee of the DR site in the cloud environment.

By calculating the use fee of the DR site in the cloud environment in this manner, the recovery method, the recovery time, and the recovery cost are estimated and presented for the unexpected data loss, thereby facilitating introduction of an appropriate disaster recovery system, and eventually facilitating appropriate and quick recovery in the disaster recovery system when the unexpected data loss occurs.

The DR cost calculation support method of the data management apparatus 1 calculates the sum of the operation fee of the DR site in the cloud environment during the recovery time and the data reading cost required for reading data from the cloud DR copy volume as the use fee of the DR site in the cloud environment from failure occurrence to completion of the system recovery (step S502 in the flowchart of the disaster support cost calculation processing in FIG. 18). This can appropriately calculate the use fee of the DR site in the cloud environment.

The DR cost calculation support method of the data management apparatus 1 calculates a set of volume copies of the volume of the disaster target and the copy volume storing data to be copied to the volume of the disaster target in the support to the disaster pattern using the main site disaster support pattern table 33 (main site disaster support pattern information) (step S201 of the flowchart of the pre-operation support pattern calculation processing of FIG. 15, step S304 of the flowchart of the in-operation normal time support pattern calculation processing of FIG. 16, and step S406 of the flowchart of the in-operation disaster: support pattern calculation processing of FIG. 17). This can more easily calculate the use fee of the DR site in the cloud environment during the recovery time.

When the operation phase is pre-operation, the DR cost calculation support method of the data management apparatus 1 calculates a disaster pattern in which the volume of the disaster target having been damaged is generated in a state where the cloud DR copy volume of the DR site in the cloud environment is being temporarily used, and calculates a set of volume copies of the volume of the disaster target and a copy volume storing copy data of the volume of the disaster target in the support to the calculated disaster pattern (see the flowchart of the pre-operation support pattern calculation processing in FIG. 15). This makes it easy for the user to know the cost required for recovery when using the cloud DR copy volume in the case where the operation phase is “pre-operation”.

When determining that there is a volume of a disaster target among the use volumes and the copy volumes of the use volumes, the DR cost calculation support method of the data management apparatus 1 calculates a set of volume copies of the volume of the disaster target having been damaged and the copy volume storing the copy data of the volume of the disaster target having been damaged in data recovery for the volume of the disaster target among the use volumes and the copy volumes of the use volumes (see the flowchart of the in-operation disaster support pattern calculation processing in FIG. 17), and calculates a use fee of a DR site in a cloud environment (see step S410 of the flowchart of the in-operation disaster support pattern calculation processing in FIG. 17 and the flowchart of the disaster support cost calculation processing in FIG. 18). This enables the user to select and recover a set of a use volume for copying data and a copy volume more quickly at the time of disaster.

The DR cost calculation support method of the data management apparatus 1 outputs a use fee for a DR site in the cloud environment. This enables the user to easily know the use fee of the DR site in the cloud environment.

The DR cost calculation support method of the data management apparatus 1 uses a use volume group name (use volume group specifying information) specifying the use volume group (see the volume group table 31 of FIG. 5 and the copy configuration table 34 of FIG. 8). This allows the use volume to be easily set.

### <Modification 1>

In the above-described example, the use volume 121 is created in the on-premises system 100. In Modification 1, the use volume 121 is created in the on-premises system 100 or a site in a cloud environment. In Modification 1, not only the use volume 121 but also the alternative host device 210 and the local backup volume 122 may be created in the site of the cloud environment.

This enables the DR cost calculation support method of the data management apparatus 1 to create the use volume not only in a site (example) in an on-premises environment but also in a site (modification 1) in a cloud environment. This enables the user to easily know the use fee of the DR site in the cloud environment for more cases (including a case where the use volume is stored in a site of a cloud environment).

The present invention is not limited to the examples described above, and includes various modifications. For example, the above-described examples have been described in detail in order to describe the present invention in an easy-to-understand manner, and are not necessarily limited to those having all the described configurations. A part of the configuration of each example can be added to, deleted from, or replaced with another configuration.

Some or all of the above configurations, functions, processing units, processing means, and the like may be implemented with hardware by, for example, designing them with an integrated circuit. The present invention can also be implemented by a program code of software that implements the functions of the examples. In this case, a storage medium recording the program code is provided to a computer, and a processor included in the computer reads the program code stored in the storage medium. In this case, the program code itself read from the storage medium implements the functions of the above-described examples, and the program code itself and the storage medium storing the same constitute the present invention. As a storage medium for supplying such a program code, for example, a flexible disk, a CD-ROM, a DVD-ROM, a hard disk, a solid state drive (SSD), an optical disk, a magneto-optical disk, a CD-R, a magnetic tape, a nonvolatile memory card, a ROM, or the like is used.

The program code for implementing the functions described in the present example can be implemented by a wide range of programs or script languages, for example, assembler, C/C++, perl, Shell, PHP, Python, Java (registered trademark), and the like.

Furthermore, a program code of software that implements the functions of the examples may be distributed via a network and stored in a storage means such as a hard disk or a memory of a computer or a storage medium such as a CD-RW or a CD-R, and a processor included in the computer may read and execute the program code stored in the storage means or the storage medium.

In the above-described examples, the control lines and the information lines indicate what is considered to be necessary for the description, and not necessarily all the control lines and the information lines on the product are indicated. All the configurations may be connected to one another.

What is claimed is:

1. A disaster recovery (DR) cost calculation support method in a data management apparatus that generates information regarding a disaster of a volume, wherein
the data management apparatus includes a storage device and a processor,
the storage device stores
copy configuration information for storing, in association with each other, business specifying information for specifying business, information of a use volume used in business, and information of a copy volume constituting a pair of a use volume and a backup or DR, and
cloud cost information for storing, in association with each other, a site in a cloud environment and information regarding a cost required for using a volume of the site in the cloud environment, and
the processor executes,
upon acquiring target business specifying information for specifying a target business,
DR operation phase determination processing of calculating an operation phase of an operation of a cloud DR copy volume of a cloud site with respect to a target business use volume based on information of a copy volume with respect to a target business use volume used in a target business with reference to the copy configuration information, support pattern calculation processing of calculating a disaster pattern that can occur in a volume of a disaster target in accordance with an operation phase calculated by the DR operation phase determination unit, and calculating a set of volume copies of the volume of the disaster target and a copy volume storing data to be recovered and copied to the volume of the disaster target in a support to a calculated disaster pattern, and disaster support cost calculation processing of calculating, using the cloud cost information, a use fee of a DR site in the cloud environment from occurrence of a failure in the disaster pattern calculated by the support pattern calculation unit to completion of system recovery of a use site where a use volume is created.

2. The DR cost calculation support method according to claim 1, wherein the disaster support cost calculation processing includes processing of calculating a sum of an operation fee of a DR site in the cloud environment during the recovery time and a data reading cost required for reading data from the cloud DR copy volume as a use fee of a DR site in the cloud environment during the recovery time.

3. The DR cost calculation support method according to claim 1, wherein
the storage unit further stores main site disaster support pattern information in which a disaster situation of a volume in a use site where the use volume is created is associated with presence or absence of use of a DR site in the cloud environment for the data recovery, and
the support pattern calculation processing includes, using the main site disaster support pattern information, processing of calculating a set of volume copies of a volume of the disaster target and a copy volume storing data to be recovered to a volume of a disaster target in a support to the disaster pattern.

4. The DR cost calculation support method according to claim 1, wherein when the operation phase calculated by the DR operation phase determination unit is pre-operation, the support pattern calculation processing includes calculating a disaster pattern in a state where the cloud DR copy volume of a DR site in the cloud environment is being temporarily used.

5. The DR cost calculation support method according to claim 1, wherein
the DR operation phase determination processing includes processing of determining whether or not there is a volume of the disaster target having been damaged among the use volume and a copy volume of the use volume, and
when it is determined that there is a volume of the disaster target having been damaged among the use volume and a copy volume of the use volume, the support pattern calculation processing includes calculating a set of volume copies of a volume of the disaster target having been damaged and a copy volume storing data to be recovered and copied to a volume of a disaster target in data recovery for a volume of the disaster target among the use volume and a copy volume of the use volume.

6. The DR cost calculation support method according to claim 1, wherein the disaster support cost calculation processing includes processing of outputting a use fee of a DR site in the cloud environment from a failure occurrence in a set of the volume copy calculated by the support pattern calculation unit to completion of system recovery of a use site where a use volume is created.

7. The DR cost calculation support method according to claim 1, wherein information on a use volume used in the business in the copy configuration information includes use volume group specifying information for specifying a use volume group including a plurality of use volumes used in the business.

8. The DR cost calculation support method according to claim 1, wherein the use volume is at least one volume of a volume created in a site in an on-premises environment and a volume created in a site in a cloud environment.

9. A data management apparatus that generates information regarding a disaster of a volume, the data management apparatus comprising a storage unit, a DR operation phase determination unit, a support pattern calculation unit, and a disaster support cost calculation unit, wherein
the storage unit stores
copy configuration information for storing, in association with each other, business specifying information for specifying business, information of a use volume used in business, and information of a copy volume constituting a pair of a use volume and a backup or DR, and
cloud cost information for storing, in association with each other, a site in a cloud environment and information regarding a cost required for using a volume of the site in the cloud environment,
the DR operation phase determination unit executes,
upon acquiring target business specifying information for specifying a target business, DR operation phase determination processing of calculating an operation phase of an operation of a cloud DR copy volume of a cloud site with respect to a target business use volume based on information of a copy volume with respect to a target business use volume used in a target business with reference to the copy configuration information,
the support pattern calculation unit executes support pattern calculation processing of calculating a disaster pattern that can occur in a volume of a disaster target in accordance with an operation phase calculated by the DR operation phase determination unit, and calculating a set of volume copies of the volume of the disaster target and a copy volume storing data to be recovered and copied to the volume of the disaster target in a support to a calculated disaster pattern, and
the disaster support cost calculation unit executes disaster support cost calculation processing of calculating, using the cloud cost information, a use fee of a DR site in the cloud environment from occurrence of a failure in the disaster pattern calculated by the support pattern calculation unit to completion of system recovery of a use site where a use volume is created.
